(19) United States
(12) Patent Application Publication
(10) Pub. No.: US 2025/0192282 A1
(43) Pub. Date: Jun. 12, 2025

(54) MULTI-FUNCTIONAL THERMAL BARRIER ASSEMBLIES FOR USE WITHIN TRACTION BATTERY PACKS

(71) Applicant: FORD GLOBAL TECHNOLOGIES, LLC, Dearborn, MI (US)

(72) Inventor: Daniel Benjamin KOK, Ann Arbor, MI (US)

(21) Appl. No.: 18/734,220

(22) Filed: Jun. 5, 2024

Related U.S. Application Data
(60) Provisional application No. 63/607,888, filed on Dec. 8, 2023.

(51) Int. Cl. H01M 10/658; B60L 50/60; H01M 10/613; H01M 10/625; H01M 10/6567; H01M 50/211; H01M 50/289

(52) U.S. Cl. CPC H01M 10/658; H01M 10/613; H01M 10/625; H01M 10/6567; H01M 50/211; H01M 50/289; H01M 2220/20

(57) ABSTRACT

Multi-functional thermal barrier assemblies may be configured to both manage thermal energy levels inside a traction battery pack and to increase the structural integrity of the traction battery pack. In some implementations, the thermal barrier assembly may include an internal cooling circuit for directing a coolant through a thermal barrier structure of the thermal barrier assembly. The thermal barrier structure may be an extrusion, a pultrusion, or an injection molded part. In other implementations, the thermal barrier assembly may include thermally insulating layers. The thermally insulating layers may be cladding layers that provide an outer skin of the thermal barrier structure.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to thermal barrier assemblies for managing thermal energy levels within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a battery cell stack, and a first thermal barrier assembly arranged to partition the battery cell stack into at least a first compartment and a second compartment. A thermal barrier structure of the first thermal barrier assembly includes an internal coolant circuit adapted for directing a coolant through the thermal barrier structure. The thermal barrier structure is a pultrusion or an extrusion.

In a further non-limiting embodiment of the foregoing traction battery pack, the thermal barrier structure includes a T-shaped cross-section.

In a further non-limiting embodiment of either of the foregoing traction battery packs, a second thermal barrier assembly is arranged to separate the first compartment or the second compartment from a third compartment of the battery cell stack.

In a further non-limiting embodiment of any of the foregoing traction battery packs, an upper sheet layer structurally couples the first thermal barrier assembly and the second thermal barrier assembly together.

In a further non-limiting embodiment of any of the foregoing traction battery packs, the upper sheet layer is a metallic plate that is secured to the first thermal barrier assembly by a first fastener and is secured to the second thermal barrier assembly by a second fastener.

In a further non-limiting embodiment of any of the foregoing traction battery packs, the first fastener and the second fastener are a weld or an adhesive.

In a further non-limiting embodiment of any of the foregoing traction battery packs, the first thermal barrier assembly includes a first thermally insulating layer and a second thermally insulating layer.

In a further non-limiting embodiment of any of the foregoing traction battery packs, the first thermally insulating layer and the second thermally insulating layer are cladding layers that establish an outer skin of the thermal barrier structure.

In a further non-limiting embodiment of any of the foregoing traction battery packs, the internal coolant circuit includes a plurality of interconnected cooling channels that establish a winding path inside the thermal barrier structure.

In a further non-limiting embodiment of any of the foregoing traction battery packs, the first thermal barrier assembly is received within a slot of a heat exchanger plate positioned adjacent to the battery cell stack.

In a further non-limiting embodiment of any of the foregoing traction battery packs, the internal coolant circuit of the thermal barrier structure is fluidly connected to an internal coolant circuit of the heat exchanger plate.

In a further non-limiting embodiment of any of the foregoing traction battery packs, the internal coolant circuit of the thermal barrier structure is fluidly connected to the internal coolant circuit of the heat exchanger plate via an inlet manifold and an outlet manifold of the first thermal barrier assembly.

In a further non-limiting embodiment of any of the foregoing traction battery packs, the inlet manifold and the outlet manifold are connected to opposite ends of the thermal barrier structure.

A traction battery pack according to another exemplary aspect of the present disclosure includes, among other things, a thermal barrier assembly arranged to partition a battery cell stack into a first compartment and a second compartment, a first plurality of battery cells positioned within the first compartment, and a second plurality of battery cells positioned within the second compartment. The thermal barrier assembly includes a thermal barrier structure, a first thermally insulating layer, and a second thermally insulating layer. The first thermally insulating layer and the second thermally insulating layer are cladding layers that establish an outer skin of the thermal barrier structure.

In a further non-limiting embodiment of the foregoing traction battery pack, the thermal barrier structure is a pultruded structure of the thermal barrier assembly.

In a further non-limiting embodiment of either of the foregoing traction battery packs, the thermal barrier structure is an extruded structure of the thermal barrier assembly.

In a further non-limiting embodiment of any of the foregoing traction battery packs, the first thermally insulating layer and the second thermally insulating layer each included mica.

In a further non-limiting embodiment of any of the foregoing traction battery packs, the thermal barrier structure of the thermal barrier assembly includes an internal coolant circuit adapted for directing a coolant through the thermal barrier structure.

In a further non-limiting embodiment of any of the foregoing traction battery packs, the internal coolant circuit of the thermal barrier structure is fluidly connected to an internal coolant circuit of a heat exchanger plate.

In a further non-limiting embodiment of any of the foregoing traction battery packs, the internal coolant circuit of the thermal barrier structure is fluidly connected to an internal cooling channel of a cross-member assembly of the battery cell stack.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view of select portions of a cell stack of a traction battery pack.

FIG. 4 illustrates a thermal barrier assembly of a cell stack of a traction battery pack.

FIG. 5 illustrates another exemplary thermal barrier assembly.

FIG. 6 illustrates yet another exemplary thermal barrier assembly.

### DETAILED DESCRIPTION

This disclosure details multi-functional thermal barrier assemblies for traction battery packs. An exemplary thermal barrier assembly may be configured to both manage thermal energy levels inside the traction battery pack and to increase the structural integrity of the traction battery pack. In some implementations, the thermal barrier assembly may include an internal cooling circuit for directing a coolant through a thermal barrier structure of the thermal barrier assembly. The thermal barrier structure may be an extrusion, a pultrusion, or an injection molded part. In other implementations, the thermal barrier assembly may include thermally insulating layers. The thermally insulating layers may be cladding layers that provide an outer skin of the thermal barrier structure. These and other features are discussed in greater detail in the following paragraphs of this detailed description.

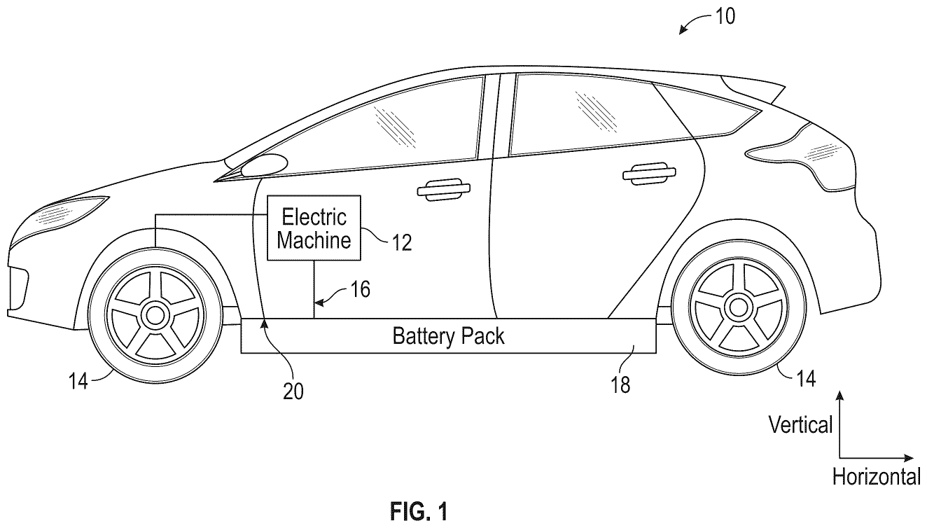

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

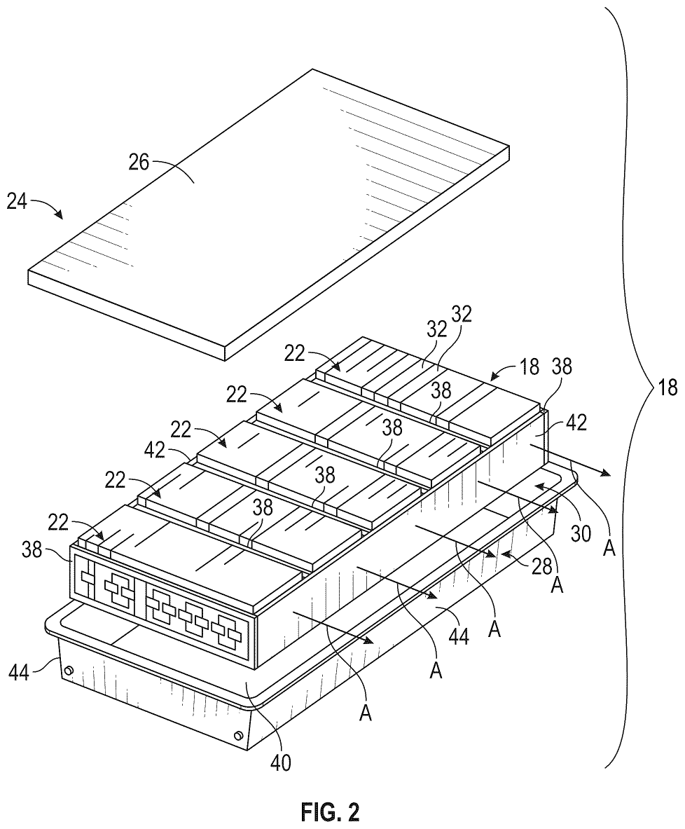

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lithium-ion phosphate, sodium-ion, etc.) could alternatively be utilized within the scope of this disclosure. The exemplary battery cells 32 can include tab terminals that project outwardly from a battery cell housing. The tab terminals of the battery cells 32 of each cell stack 22 are connected to one another, such as by one or more busbars, for example, in order to provide the voltage and power levels necessary for achieving vehicle propulsion.

The battery cells 32 of each cell stack 22 may be arranged between a pair of cross-member assemblies 38. Among other functions, the cross-member assemblies 38 may be configured to hold the battery cells 32 and at least partially delineate the cell stacks 22 from one another when placed within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed within the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The cell stacks 22 may be arranged to extend along their respective cell stack axes A between opposing end plates 42. One or more end plates 42 may be positioned between each end of each cell stack 22 and a longitudinally extending side wall 44 of the enclosure tray 28. The end plates 42 may therefore extend along axes that are substantially transverse (e.g. perpendicular) to the cell stack axes A of the cell stacks 22 and the cross-member assemblies 38. In some implementations, the end plates 42 are structural members that span across a majority of the length of the longitudinally extending side wall 44 of the enclosure tray 28. However, other configurations are contemplated within the scope of this disclosure.

In an embodiment, the cell stacks 22 and the cross-member assemblies 38 extend longitudinally in a cross-vehicle direction of the electrified vehicle 10, and the end plates 42 extend longitudinally in a length-wise direction of the electrified vehicle 10. However, other configurations are contemplated within the scope of this disclosure.

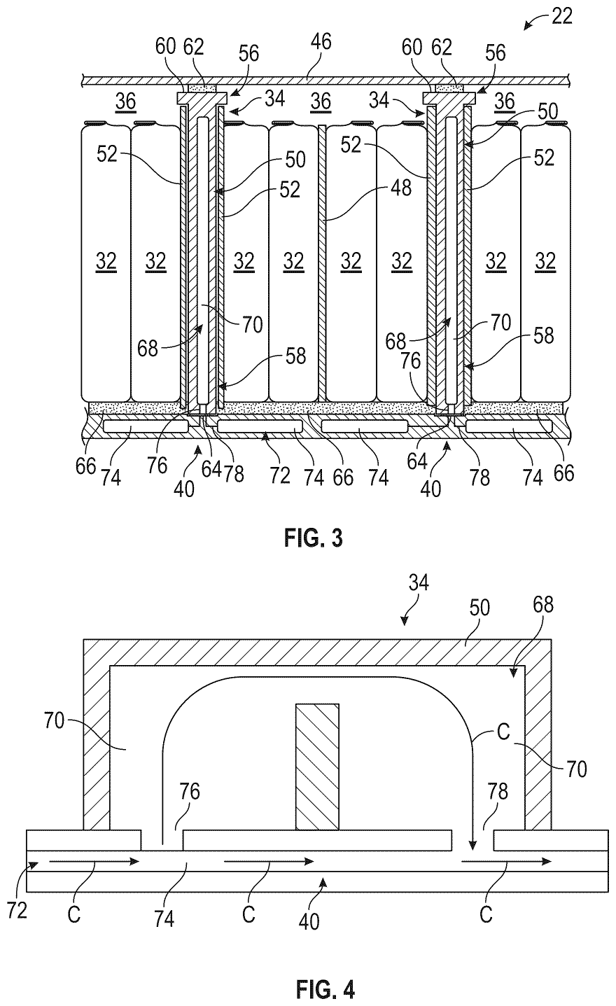

Referring now to FIG. 3, with continued reference to FIGS. 1-2, one or more thermal barrier assemblies 34 may be arranged along the respective cell stack axis A of each cell stack 22. The thermal barrier assemblies 34 may compartmentalize each cell stack 22 into two or more groupings or compartments 36 of battery cells 32. Each compartment 36 may hold one or more of the battery cells 32 of the cell stack 22. In an embodiment, each compartment 36 holds four battery cells 32. However, other configurations are contemplated within the scope of this disclosure.

A cell expansion pad 48 may be arranged between neighboring battery cells 32 within each compartment 36 of the cell stack 22. In an embodiment, one cell expansion pad 48 is disposed between adjacent groups of two battery cells 32 within each compartment 36. However, other configurations are contemplated within the scope of this disclosure. The cell expansion pads 48 may include any material(s) (e.g., polyurethane foam, silicone foam, etc.) that is adapted for accommodating battery cell swelling.

The thermal barrier assemblies 34 may be configured to thermally manage the battery cells 32 during normal operating conditions of the traction battery pack 18. In addition, in the event of a battery thermal event occurring in one of the cell stacks 22, the thermal barrier assemblies 34 may reduce or even prevent thermal energy associated with the thermal event from moving from cell-to-cell, compartment-to-compartment, and/or cell stack-to-cell stack, thereby inhibiting the transfer of thermal energy inside the traction battery pack 18.

Each thermal barrier assembly 34 of the cell stack 22 may include a thermal barrier structure 50 that is flanked by a pair of thermally insulating layers 52 as part of a multi-layer structure of the thermal barrier assembly 34. In the illustrated embodiment, the thermal barrier structure 50 may be sandwiched between the thermally insulating layers 52.

The thermal barrier structure 50 could include a metallic body, a thermoplastic body, a thermoset body, or a polymer composite body (e.g., glass fiber reinforced polypropylene with an intumescent additive), for example, and the thermally insulating layers 52 may each be made of one or more thermally resistant (and thus low thermal conductivity) materials such as mica, aerogel materials, refractory ceramic fibers, etc., for example. However, other materials or combinations of materials could be utilized within the scope of this disclosure.

The thermal barrier structure 50 of the thermal barrier assembly 34 may be a pultrusion, which implicates structure to this component. A person of ordinary skill in the art having the benefit of this disclosure would understand how to structurally distinguish a pultruded structure from another type of structure, such as an extrusion, for example. The thermal barrier structure 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the thermal barrier structure 50. In other implementations, the thermal barrier structure 50 could include an extruded structure.

The thermal barrier structure 50 of the thermal barrier assembly 34 may include an upper interfacing structure 56 that is configured to interface with an upper sheet layer 46 (e.g., a metallic plate) of the cell stack 22, and a lower interfacing structure 58 that is configured to interface with the heat exchanger plate 40. Together, the upper interfacing structure 56 and the lower interfacing structure 58 may establish a T-shaped cross-section of the thermal barrier structure 50. However, other shapes are contemplated within the scope of this disclosure.

The upper interfacing structure 56 may provide an upper plateau 60 for securing the thermal barrier assembly 34 to the upper sheet layer 46 via a fastener 62. The fastener 62 may be a weld or an adhesive (e.g., epoxy based adhesive or a urethane based adhesive), for example. The upper sheet layer 46 may be secured to multiple thermal barrier assemblies 34 of the cell stack 22 in order to structurally integrate the thermal barrier assemblies 34 with one another. Once the upper interfacing structure 56 is secured relative to the upper sheet layer 46, the thermal barrier assembly 34 can substantially prevent thermal energy from moving from one compartment 36 to another at the sealed interface between the thermal barrier assembly 34 and the upper sheet layer 46, such as during a battery thermal event, for example.

The lower interfacing structure 58 may be disposed on an opposite end of the thermal barrier structure 50 from the upper interfacing structure 56. The lower interfacing structure 58 may be received within a slot 64 formed in the heat exchanger plate 40, such as via a press-fit, for example. The lower interfacing structure 58 may therefore help locate the thermal barrier assembly 34 relative to the heat exchanger plate 40 during traction battery pack assembly.

In an embodiment, the thermally insulating layers 52 are cladding layers of the thermal barrier assembly 34. The thermally insulating layers 52 may therefore provide an outer skin portion of the lower interfacing structure 58 of the thermal barrier structure 50.

A thermal interface material 66 (e.g., epoxy resin, silicone based materials, thermal greases, etc.) may disposed between the battery cells 32 of the cell stack 22 and the heat exchanger plate 40. The thermal interface material 66 may be configured to facilitate heat transfer between the battery cells 32 and the heat exchanger plate 40.

Once the upper interfacing structure 56 is joined to the upper sheet layer 46 (or alternatively to the enclosure cover 26) and the lower interfacing structure 58 is joined to the heat exchanger plate 40 (or alternatively to the enclosure tray 28), the upper sheet layer 46 and the heat exchanger plate 40 are effectively structurally coupled to one another. The thermal barrier assemblies 34 can therefore be configured for increasing the structural stiffness of the traction battery pack 18. The thermal barrier assemblies 34 could additionally be structurally connected to the cross-member assembly 38 or to a busbar module with an adhesive and/or sealant.

Referring now to FIGS. 3 and 4, each thermal barrier assembly 34 may be configured to thermally manage the battery cells 32 of the cell stack 22. For example, heat may be generated and released by the battery cells 32 of the cell stack 22 during charging operations, discharging operations, extreme ambient conditions, etc. It may be desirable to actively remove the heat from the cell stack 22 to enhance the capacity and life of the battery cells 32. Each thermal barrier assembly 34 may thus be configured as a heat exchanger or “cold plate” for conducting the heat out of the battery cells 32.

The thermal barrier structure 50 of each thermal barrier assembly 34 may include an internal coolant circuit 68 for performing the heat transfer functions described in the preceding paragraph. A coolant C may be selectively circulated through the internal coolant circuit 68 to thermally condition the battery cells 32 of adjacent compartments 36 of the cell stack 22. In an embodiment, the coolant C is a conventional type of coolant mixture such as water mixed with ethylene glycol. However, other coolants, including gases and dielectric fluids, are also contemplated within the scope of this disclosure.

The internal coolant circuit 68 may include a series of interconnected cooling channels 70 that extend inside the thermal barrier structure 50. The cooling channels 70 may be fluidly connected to one another and may be arranged in various patterns inside the thermal barrier structure 50. In an embodiment, the cooling channels 70 are configured to establish a winding or serpentine path for circulating the coolant C through the thermal barrier structure 50. However, other patterns could alternatively be utilized within the scope of this disclosure. For example, the various cooling channels 70 can be configured in different sizes, shapes, and paths to help meter and balance the flow of the coolant C through the internal coolant circuit 68. The size and shape of each cooling channel 70 and the total number of cooling channels 70 are thus not intended to limit this disclosure and can be specifically tuned to address the particular cooling requirements of the cell stack 22.

The heat exchanger plate 40 may additionally include an internal coolant circuit 72 that includes a series of cooling channels 74 that extend inside the heat exchanger plate 40. The cooling channels 74 may be fluidly connected to one another and may be arranged in various patterns inside the heat exchanger plate 40. In an embodiment, the cooling channels 74 are configured to establish a winding or serpentine path for circulating the coolant C through the heat exchanger plate 40. The size and shape of each cooling channel 74 and the total number of cooling channels 74 are thus not intended to limit this disclosure and can be specifically tuned to address the particular cooling requirements of the cell stack 22.

The internal coolant circuit 68 of the thermal barrier assembly 34 may be fluidly connected to the internal coolant circuit 72 of the heat exchanger plate 40 for communicating the coolant C therebetween. For example, in use, the coolant C may be communicated from the internal coolant circuit 72 of the heat exchanger plate 40 into an inlet 76 of the internal coolant circuit 68 of the thermal barrier assembly 34. The coolant C may then be communicated through the cooling channels 70 of the internal coolant circuit 68 before exiting through an outlet 78 of the internal coolant circuit 68. In an embodiment, the inlet 76 and the outlet 78 are connected to different cooling channels 74 of the heat exchanger plate 40. However, other configurations are contemplated within the scope of this disclosure. The coolant C exiting the outlet 78 may be returned to the internal coolant circuit 72 of the heat exchanger plate 40. The coolant C may pick up heat released by the battery cells 32 of the cell stack 22 as it meanders along the path of the internal coolant circuit 68, thereby carrying away excessive heat and stabilizing the temperatures of the battery cells 32.

The coolant C may enter and exit the heat exchanger plate 40 as part of a closed-loop liquid cooling system. Although not shown, the coolant C exiting from the internal coolant circuit 72 of the heat exchanger plate 40 may be delivered to a radiator or some other heat exchanging device, be cooled, and then returned to an inlet of the internal coolant circuit 72 as part of the closed loop liquid cooling system.

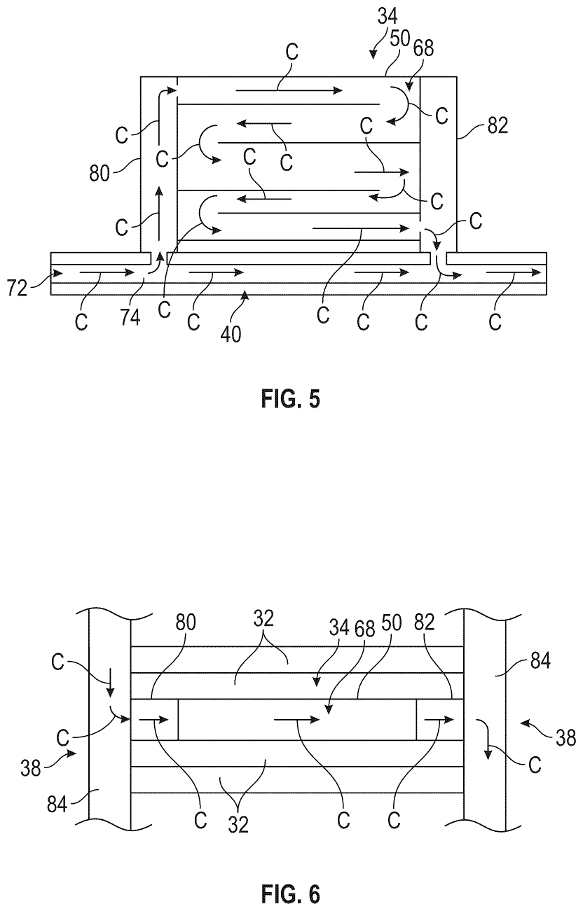

In alternative embodiments such as those illustrated by FIGS. 5 and 6, for example, the thermal barrier assembly 34 may include an inlet manifold 80 and an outlet manifold 82. The inlet manifold 80 and the outlet manifold 82 may be attached to opposite ends of the thermal barrier structure 50. The coolant C may enter the internal coolant circuit 68 of the thermal barrier assembly 34 via the inlet manifold 80 and may exit the internal coolant circuit 68 via the outlet manifold 82.

In an embodiment, the inlet manifold 80 and the outlet manifold 82 may be fluidly connected to the internal coolant circuit 72 of the heat exchanger plate 40 (see, e.g., the configuration of FIG. 5). In another embodiment, the inlet manifold 80 and the outlet manifold 82 may be fluidly connected to an internal cooling channel 84 of one of more cross-member assemblies 38 of the cell stack 22 (see, e.g., the configuration of FIG. 6).

The multi-functional thermal barrier assemblies of this disclosure can thermally manage battery cells during both normal battery operating conditions and battery thermal conditions. The exemplary thermal barrier assemblies may act as cold plates for thermally managing battery cells and may further act as structural members for structurally integrating the traction battery pack.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery cell stack;
a first thermal barrier assembly arranged to partition the battery cell stack into at least a first compartment and a second compartment; and
a thermal barrier structure of the first thermal barrier assembly including an internal coolant circuit adapted for directing a coolant through the thermal barrier structure,
wherein the thermal barrier structure is a pultrusion or an extrusion.

2. The traction battery pack as recited in claim 1, wherein the thermal barrier structure includes a T-shaped cross-section.

3. The traction battery pack as recited in claim 1, comprising a second thermal barrier assembly arranged to separate the first compartment or the second compartment from a third compartment of the battery cell stack.

4. The traction battery pack as recited in claim 3, comprising an upper sheet layer that structurally couples the first thermal barrier assembly and the second thermal barrier assembly together.

5. The traction battery pack as recited in claim 4, wherein the upper sheet layer is a metallic plate that is secured to the first thermal barrier assembly by a first fastener and is secured to the second thermal barrier assembly by a second fastener.

6. The traction battery pack as recited in claim 5, wherein the first fastener and the second fastener are a weld or an adhesive.

7. The traction battery pack as recited in claim 1, wherein the first thermal barrier assembly includes a first thermally insulating layer and a second thermally insulating layer.

8. The traction battery pack as recited in claim 7, wherein the first thermally insulating layer and the second thermally insulating layer are cladding layers that establish an outer skin of the thermal barrier structure.

9. The traction battery pack as recited in claim 1, wherein the internal coolant circuit includes a plurality of interconnected cooling channels that establish a winding path inside the thermal barrier structure.

10. The traction battery pack as recited in claim 1, wherein the first thermal barrier assembly is received within a slot of a heat exchanger plate positioned adjacent to the battery cell stack.

11. The traction battery pack as recited in claim 10, wherein the internal coolant circuit of the thermal barrier structure is fluidly connected to an internal coolant circuit of the heat exchanger plate.

12. The traction battery pack as recited in claim 11, wherein the internal coolant circuit of the thermal barrier structure is fluidly connected to the internal coolant circuit of the heat exchanger plate via an inlet manifold and an outlet manifold of the first thermal barrier assembly.

13. The traction battery pack as recited in claim 12, wherein the inlet manifold and the outlet manifold are connected to opposite ends of the thermal barrier structure.

14. A traction battery pack, comprising:
a thermal barrier assembly arranged to partition a battery cell stack into a first compartment and a second compartment;
a first plurality of battery cells positioned within the first compartment;
a second plurality of battery cells positioned within the second compartment; and
the thermal barrier assembly including a thermal barrier structure, a first thermally insulating layer, and a second thermally insulating layer,
wherein the first thermally insulating layer and the second thermally insulating layer are cladding layers that establish an outer skin of the thermal barrier structure.

15. The traction battery pack as recited in claim 14, wherein the thermal barrier structure is a pultruded structure of the thermal barrier assembly.

16. The traction battery pack as recited in claim 14, wherein the thermal barrier structure is an extruded structure of the thermal barrier assembly.

17. The traction battery pack as recited in claim 14, wherein the first thermally insulating layer and the second thermally insulating layer are each comprised of mica.

18. The traction battery pack as recited in claim 14, wherein the thermal barrier structure of the thermal barrier assembly includes an internal coolant circuit adapted for directing a coolant through the thermal barrier structure.

19. The traction battery pack as recited in claim 18, wherein the internal coolant circuit of the thermal barrier structure is fluidly connected to an internal coolant circuit of a heat exchanger plate.

20. The traction battery pack as recited in claim 18, wherein the internal coolant circuit of the thermal barrier structure is fluidly connected to an internal cooling channel of a cross-member assembly of the battery cell stack.
